(19) United States
(12) Patent Application Publication
(10) Pub. No.: US 2016/0100572 A1
(43) Pub. Date: Apr. 14, 2016

(54) Enhancement Of Insecticides Against Codling Moth (Lepidoptera: Tortricidae) With L-Aspartate

(71) Applicant: Missouri State University, Springfield, MO (US)

(72) Inventors: Maciej A. Pszczolkowski, Mountain Grove, MO (US); John J. Brown, Pullman, WA (US)

(21) Appl. No.: 14/878,823

(22) Filed: Oct. 8, 2015

Related U.S. Application Data
(60) Provisional application No. 62/061,625, filed on Oct. 8, 2014.

(51) Int. Cl. A01N 25/00; A01N 53/00; A01N 47/40; A01N 47/22; A01N 43/22

(52) U.S. Cl. CPC A01N 25/00; A01N 47/22; A01N 43/22; A01N 47/40; A01N 53/00

(57) ABSTRACT

The invention includes a method for enhancing insecticide efficacy against phytophagous insects with an acidic amino acid feeding stimulator. The acidic amino acid, L-aspartate, stimulates feeding in codling moth neonates at much lower concentrations than known feeding stimulators and acts as an effective tank-mixed additive for increasing efficacy of insecticides, reducing fruit damage, and increasing yield of the fruit.

### RELATED APPLICATION

This application claims the benefit of the earlier filed Provisional Application No. 62/061,625 filed Oct. 8, 2014.

### BACKGROUND

Codling moth (Cydia pomonella (L.)) is a major, cosmopolitan, and difficult-to-control pest of apples. In most locations, it has two or three full generations per year, and in unmanaged orchards, fruit infestation by this species may reach 80% which potentially, may translate to losses exceeding US$2.1 billion in the United States alone.

Codling moths infest apples after hatching from eggs, as neonate larvae, and they stay inside the fruit until their development is complete. Consequently, growers have limited means to control this insect. In the past, efforts to control the moths included application of insecticides, mating disruption and cultural controls. Biological controls, including the introduction of the parasite Trichogramma platneri have shown limited success and is generally too expensive to undertake.

Until September 2012, despite growing pressure from the public and the legislatures, broad-spectrum insecticides such as azinphos-methyl were still used to target neonates before entering the fruit, even though this insecticide has to be applied in amounts exceeding 1.7 kg/ha due to resistance that has accumulated over years. Insect ryanodine receptor activator, chloran-traniliprole, chloride channel activator, emamectin benzoate, and disruptors of nicotinic-D′y amino butyric acid (GABA)-gated chloride channels, such as Spinetoram, have been implemented against codling moth in the United States and in Europe, but it is suspected that resistance against these insecticides will happen over a period of time. Microbial insecticides such as Bacillus thurin-giensis or C. pomonella granulovirus could be used against codling moth neonates, but these insecticides must be consumed in large quantities to exert effects, thus their efficacy is often too low to protect fruit quality.

Strategies based on behavioral manipulation with pheromones or kairomones such as mating disruption or attract-and-kill are efficient on large and well-managed apple plantations. However, they are expensive and do not resolve problems caused by dense codling moth populations, migration of gravid moths from adjacent unmanaged areas in mosaic landscapes typical of small-scale apple production or insecticide resistance. More recently, studies on microencapsulated kairomones against codling moth showed promising results

There are several lines of evidence that codling moth neonates feeding behavior could be manipulated to the benefit of the grower. In North Carolina, between May and August (for over half of the season), codling moths oviposit mostly on foliage. The same was reported for July, August, and September in some orchards in eastern Washington. Thus, in many cases, the larva travels a distance across the foliage and twigs before it locates a suitable apple and infests it. Next, the neonate collects chemical stimuli during its post-hatch exploration of foliage and qualities of these stimuli determine the subsequent choice of host fruit. Moreover, codling moth neonates can be stimulated to feed on apple foliage with monosodium glutamate during post-hatch period of foliage exploration. Feeding stimulants could be tank-mixed with insecticides to improve their efficacy against codling moth.

Addition of feeding stimulants to insecticides to enhance their intake (and reduce the amounts of active ingredients needed for effective pest control) is well known. It has also been shown, using small-scale field trials and laboratory assays, that spino sad enhanced with monosodium glutamate is more effective against codling moth neonates than the same insecticide used alone. However, monosodium glutamate is highly dissoluble in water, and its use is impractical because of reduced rain fastness. Characterization of putative chemoreceptors that participate in perceiving monosodium glutamate by codling moth neonates led to proposing several new feeding stimulants of lower water solubility and better rain fastness. One of these, trans-ACBD, showed very promising characteristics, and allowed reduction of insecticide active ingredient by >50% without sacrificing efficacy, but this chemical is produced on a small scale for experimental purposes, as it is far too expensive to be used on a larger scale in agricultural operations. In a more recent studies, the feeding stimulatory properties of L-aminophosphono acids on codling moth neonates have been studied and found that these acids that have amino and carboxylic acid groups attached in L-conformation to shorter aliphatic hydrocarbon chains exhibit higher feeding stimulatory activity. Thus, L-aspartate was selected as a new candidate for insecticide enhancer against codling moth neonates. Indeed, L-aspartate induces feeding in codling moth neonates. Whether L-aspartate increases foliage consumption by codling moth neonates or might be used for insecticide enhancement was not studied.

### GENERAL DESCRIPTION

The basis for this invention arises from studying the effects of L-aspartate on food consumption by codling moth neonates in laboratory experiments. It is demonstrated that addition of L-aspartate to commercially available insecticide formulations increases efficacy of these insecticides in laboratory trials. Tank mixing of L-aspartate into commercially available insecticide formulations decreases damage caused by codling moth in field experiments.

### BRIEF DESCRIPTION OF THE DRAWINGS

FIG. 1 is a graph showing stimulated foliage consumption.

FIG. 2 is a graph showing the effect of stimulants on fruit growth.

FIG. 3 is a graph showing increased foliage consumption with the application of L-Aspartate.

### MATERIALS AND METHODS

Codling moth adults (C. pomonella) were obtained from the U.S. Department of Agriculture Research Service (USDAD ARS) at Yakima, Wash. The moths were kept at 25° C., 70-80% relative humidity, and a photoperiod of 16:8 (L:D) h. Polyethylene foil was provided as an oviposition surface. Egg hatch began about 6 hours into the photophase. In all experiments, 0.5-1 hour posthatch neonates were used.

Chemicals and Insecticides. L-Aspartic acid of reagent grade and Triton X-100 were purchased from Sigma, St. Louis, Mo. Baythroid XL (12.7% J3-cyfluthrin), Delegate WG (25% spinetoram), Carbaryl 80S (80% carbaryl), and Surf-Ac 820 (nonionic surfactant) were purchased in a local fertilizer and hardware store (Midwest Grower Supply, Stanberry, Mo.). Assail 30 SG (30% acetamiprid) was supplied by United Phosphorus Inc., King of Prussia, Pa.

Feeding Stimulation by L-Aspartate. The feeding behavior of test larvae was assessed on apple leaf sections treated with L-aspartate solutions, and by a quantitative analysis of the amounts of leaf tissue ingested. Briefly, L-aspartate was dissolved in 0.02% Triton X-100 in distilled water, and the following concentrations were used for treatment of experimental sections: 0.01, 0.1, and 1 mg/ml. Control leaves were treated with the 0.02% aqueous Triton X-100 only. Circular sections of uniform size (12 mm in diameter) were removed from Honeycrisp (U.S. Pat. No. 7,197) foliage, avoiding the leaf rib area. Test solutions (10 μl) were distributed over the upper surface of the excised sections that subsequently were allowed to air-dry. The same procedure was used for treatment of the sections' lower surfaces. Treated sections were placed in bioassay stations and each section was infested with one neonate larva. The surface area of each leaf disc that was consumed was determined using a stereomicroscope equipped with an ocular square mesh reference scale (No. 12-561-RG2; Fisher, Pittsburgh, Pa.). Thirty-three fragments of leaves, chosen randomly from midrib areas of the leaves, were also measured visually and then dried and weighed to establish a relationship between optical measurement and weight of foliage consumed. Based on this determination, consumed areas of the leaf were converted to an estimated dry weight of leaf tissue.

Thirty to forty neonate larvae were tested individually to each concentration of L-aspartate. The amount of leaf tissue consumed by neonates was estimated 3 and 24 hours after infestation of each bioassay station, and was expressed as average (mean±SEM) leaf consumption.

Insecticide Enhancement With L-Aspartate: Laboratory Assays. Insecticide enhancement with L-aspartate was studied by establishing LC₅₀ for Assail 30 SG, Baythroid XL, Delegate WG, or Carbaryl 80S alone or enhanced with 1 mg/ml L-aspartate. Each tested sample was prepared in aqueous 0.02% Triton X-100, applied to apple foliage, and the neonates were tested for mortality in the bioassay stations as in the study of feeding stimulation by L-aspartate. Preliminary screening of the insecticides without the addition of L-aspartate was performed using concentrations over eight orders of magnitude (0.000000001-0.1 mg/ ml). The screening suggested 5-8 concentrations so that the lowest and the highest would yield between 0 and 100% mortality, respectively. Ninety-one to one hundred larvae were exposed to each concentration. Mortality was assessed after 24 hours. In the next step, the experimental procedure was repeated, but this time 1 mg/ml L-aspartate was added to each tested sample. The LC₅₀, were calculated using POLO PLUS (LeOra Software Company, Petaluma, Calif.). Enhancement ratio was calculated by dividing LC₅₀ for each insecticide alone by LC₅₀ for respective insecticide in combination with L-aspartate.

In another experiment, it was tested whether L-aspartate maintains its feeding stimulatory properties in presence of tested insecticide. To that end, for each insecticide, the respective LC10, LC30, and LC50 were calculated using POLO PLUS and used in preliminary tests. Preliminary experiments showed most promising results when the LC₃₀ₛ were used, thus those concentrations (2.67 mg [AI]/liter for Carbaryl 80S, 0.03 mg [AI]/liter for Delegate WG, 0.49 mg [AI]/liter for Assail 30 SG, and 0.0013 mg [AI]/liter for Baythroid XL) were used in subsequent tests. Apple foliage was treated with LC₃₀ of respective insecticide alone or in combination with 1 mg/ml L-aspartate, and codling moth neonates were individually exposed to treated foliage as in the study of feeding stimulation by L-aspartate. There were two additional groups in this experiment: one established on foliage treated with 1 mg/ml L-aspartate only and one treated with solvent (aqueous 0.02% Triton X-100) only. Each group consisted of 64-66 individually tested neonates. Twenty-four hours after infestation of each bioassay station, amount of leaf tissue consumed by neonates was estimated as described in the experiment on feeding stimulation of L-aspartate, and was expressed as average (mean±SEM) leaf consumption.

Insecticide Enhancement With L-Aspartate: Field Trials. Field trials were performed in 2010, 2011, and 2012 in a research orchard at the Missouri State Fruit Experiment Station in Mountain Grove, Mo. Preliminary studies showed that codling moth has two generations per year in this location. A 1-hectare apple research block was set up for the research. In addition to codling moth, two lepidopteran apple pests occurred in the apple research block during the experiments; the redbanded leaf roller, Argyrotaenia velutinana (Walker), and the oriental fruit moth, Grapholita mo-lesta (Busck). To combat these pests and diseases, the block was treated with a standard program of fungicides and insecticides alone or with addition of L-aspartate. An untreated 0.5-hectare refuge for the lepidopteran pests consisting of apple trees that were not treated with fungicides or insecticides was set up on the periphery of the block to provide moderate pressure from the pests, including codling moth.

The same experimental routine was followed each year. Apple trees of Stark Gala variety on M7A rootstock were used in fully randomized design for eight replicates and three treatments (a given insecticide alone, L-aspartate in combination with a given insecticide, and untreated control). Codling moth populations in experimental plots were monitored using delta traps baited with 0.16% codlemone (8E,10E-dodecadien-1-ol). Whenever a weekly count of codling moth males in the traps reached or exceeded five males per trap, an insecticide was applied within the next 1-2 days. The following insecticides were used: Assail 30 SG (30% acetamiprid) at 9 g/100 liters (140 g [AI]/ha), Bay-throid XL (12.7% β-cyfluthrin) at 4 ml/100 liters (23.7 g [AI]/ha), Delegate WG (25% spinetoram) at 31 ml/100 liters (63.9 g [AI]/ha), and Carbaryl 80S (80% carbaryl) at 60 g/100 liters (2.24 g [AI]/ha).

For each replicate, one tree received a spray with an insecticide tank-mixed with L-aspartate. Concentration of L-aspartate was 211 g/100 liters, which corresponded to 395 g/ha. Next, one tree in each replicate was sprayed with the respective insecticide only. Surf-Ac 820 (2.1 kg/ha, 50 g/100 liters) was used as a surfactant in either spray with L-aspartate-insecticide combination or with the respective insecticide only. In addition, one tree in each replicate was left untreated.

In total, eight sprays (two with Carbaryl 80S, three with Assail 30 SG, two with Delegate WG, and one with Baythroid XL) were applied in 2010, six (two with Baythroid XL, two with Assail 30 SG, one with Delegate WG, and one with Carbaryl 80S) in 2011, and seven (three with Assail 30 SG, two with Baythroid XL, and two with Carbaryl 80S) in 2012. Sprays (at delivery rate=4673 liters/ha) were performed using a custom-made motorized handgun sprayer with nine separate tanks (Friend Manufacturing Corporation, Gasport, N.Y.) capable of sending the spray precisely into canopy of height up to 4 meters. To minimize spray drift, a tarpaulin screen was used.

Each year, 200 apples were sampled from each experimental trees treated with insecticide-L-asparate combination, each control tree (treated with insecticides only), and from each untreated tree. One hundred apples per tree were collected 2 weeks after the first flight of codling moth (May 2010, early June in 2011, and May 2012). Remaining apples (100 per tree) were collected at harvest (August in 2010 and 2011 and July in 2012). The method of collection was similar to that used by Childers and Enns (1975) for monitoring arthropods in Missouri apple orchards. Briefly, 33-34 apples were collected from each of three zones within the canopy (close to the trunk, from the middle of the distance in between the trunk and the tips of the branches, and from the outside portion of the canopy to within 10-15 cm inside). Each time a vertical area from the bottom to the top of the canopy was randomly sampled in a circuitous design around the tree. The apples were immediately weighed and inspected for damage in the laboratory. Once damage was found, the fruit was carefully fragmented with a paring knife, and internal fruit feeders (in some fruits larvae of oriental fruit moth were found) were collected and examined under a stereomicroscope. Codling moth larvae were discriminated from oriental fruit moth larvae by absence of anal comb (Il'ichev et al. 2006). Superficial fruit damage was not taken into consideration, as damage by the oriental fruit moth could not be differentiated from damage caused by the codling moth. Apple weight was expressed as average±SEM weight. Damage was expressed as average±SEM percentage of sampled fruit that was infected by codling moth larvae.

Statistics. Data on apple weight were analyzed with Student's t-test. For mortality studies, probit analysis was performed using POLO PC. Remaining data were subjected to analysis of variance (ANOVA), using GraphPad InStat, (GraphPad Software Inc., San Diego, Calif.)

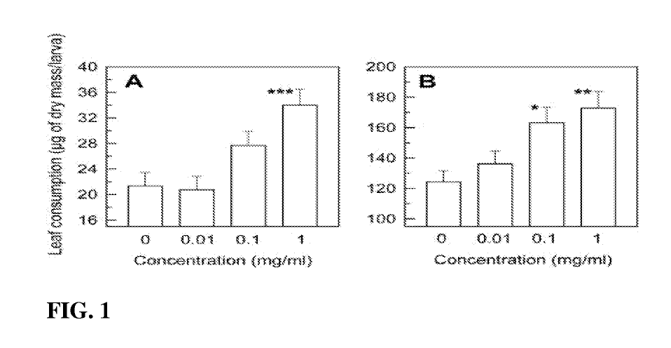

Feeding Stimulation by L-Aspartate. L-Aspartate stimulated foliage consumption both in 3- and 24-hour assays as shown in FIG. 1. After 3 hours, at concentration of 1 mg/ml, L-aspartate increased foliage consumption by approximately 60% in comparison with control (shown in FIG. 1A; N=37; P<0.001, ANOVA). After 24 hours, foliage consumption increased by approximately 30% at 0.1 mg/ml L-aspartate (shown in FIG. 1; N=36, P<0.01, ANOVA), and by approximately 40% at 1 mg/ml L-aspartate (FIG. 1B; N=37; P<0.001, ANOVA).

Insecticide Enhancement With L-Aspartate: Laboratory Assays. Addition of 1 mg/ml L-aspartate increased efficacy of Assail 30 SG, Baythroid XL, Delegate WG, and Carbaryl 80S by a factor of approximately 10 (Table 1).

TABLE 1

| Experimental | N | | Slope (±SE) | | X2 |
|---|---|---|---|---|---|
| Carbaryl 80S alone | 580 | 1.729 ± 0.131 | 5.362 | (2.330-10.171) | 28.631 |
| Carbaryl 80S + | 579 | 2.395 ± 0.163 | 0.497 | (0.288-0.787) | 23.920 |
| L-aspartate | | | | | |
| Delegate WG alone | 486 | 3.518 ± 0.263 | 0.039 | (0.290-0.520) | 6.972 |
| Delegate WG + | 493 | 3.692 ± 0.284 | 0.003 | (0.002-0.003) | 2.657 |
| L-aspartate | | | | | |
| Assail 30 SG alone | 579 | 1.572 ± 0.141 | 1.051 | (0.650-1.467) | 6.786 |
| Assail 30 SG + | 578 | 2.408 ± 0.195 | 0.102 | (0.088-0.117) | 0.857 |
| L-aspartate | | | | | |
| Baythroid XL alone | 584 | 1.385 ± 0.121 | 0.0031 | (0.00254-0.00374) | 16.328 |
| Baythroid XL + | 576 | 2.103 ± 0.162 | 0.00025 | (0.00015-0.00037) | 1.368 |
| L-aspartate | | | | | |

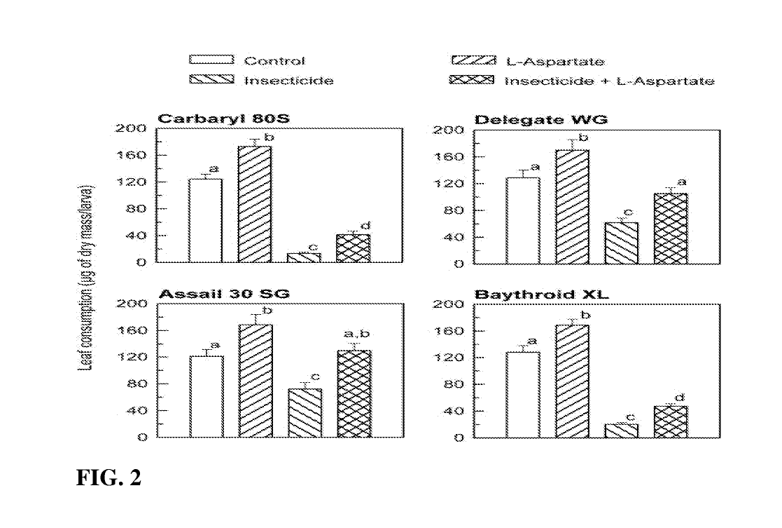

Each insecticide treatment decreased the amount of foliage consumed, but L-aspartate maintained its feeding stimulatory properties even in the presence of each insecticide (FIG. 2; N=64-66; P<0.05, ANOVA). In the case of Delegate WG and Assail 30 SG, the consumption of foliage was stimulated by L-aspartate to the levels of untreated control (FIG. 2; N=65-66; P<0.05, ANOVA). However, in no case did the amounts of foliage consumed by codling moth neonates exposed to combination of tested insecticide and L-aspartate reach the level of foliage consumption caused by exposure to L-aspartate alone (FIG. 2; N=64-66; P>0.05, ANOVA).

Insecticide Enhancement With L-Aspartate: Field Trials. In all years, fruit damage by first-generation neonates was slightly lower than 20% (Table 2), and was significantly reduced by insecticide sprays (Table 2; N=8; P<0.001, ANOVA). Addition of L-aspartate further reduced fruit damage by first-generation codling neonates (Table 2; N=8; P<0.05, ANOVA). In 2010, addition of L-aspartate reduced fruit damage from approximately 6% on average to <1%; in 2011, these percentages averaged 4.6 and 1.2%, respectively. In 2012, addition of L-aspartate resulted in a reduction from 6.2 to 1% damage.

TABLE 2
Effects of L-aspartate tank-mixed with insecticides (see text
for spray details) on fruit damage by codling moth larvae

| | % damage year 2010 | | % damage year 2011 | | % damage year 2012 | |
|---|---|---|---|---|---|---|
| | First | Second | First | Second | First | |
| Treatment | generation | generation | generation | generation | generation | |
| Unsprayed control | 19.41 ± 1.02a | 69.94 ± 6.42a | 18.36 ± 1.47a | 73.04 ± 4.46a | 18.21 ± 1.27a | 62.67 ± 5.35a |
| Insecticides alone | 6.23 ± 0.76b | 19.97 ± 1.71b | 4.62 ± 0.61b | 8.69 ± 2.41b | 5.85 ± 1.64b | 23.74 ± 3.66b |
| Insecticides + L- | 1.02 ± 0.12c | 4.86 ± 1.64c | 1.21 ± 0.11c | 8.62 ± 1.97b | 0.67 ± 0.49c | 4.94 ± 2.67c |

Similar trends were observed for second-generation neonates in 2010 and in 2012 (Table 2). Fruit damage oscillated approximately 60-70% in untreated trees and was significantly reduced by insecticide sprays (Table 2; N=8; P<0.001). However, the insecticide-enhancing effect of L-aspartate was observed only in 2010 and in 2012. In both cases, application of insecticides enhanced with L-aspartate resulted in statistically significant (N=8; P<0.05, ANOVA) reduction of fruit damage from approximately 20 to approximately 5%. In 2011, such effect was not observed. Here, both the fruit treated with insecticides and with insecticide-L-aspartate combinations showed similar degree of damage (approximately 8.6% in either case).

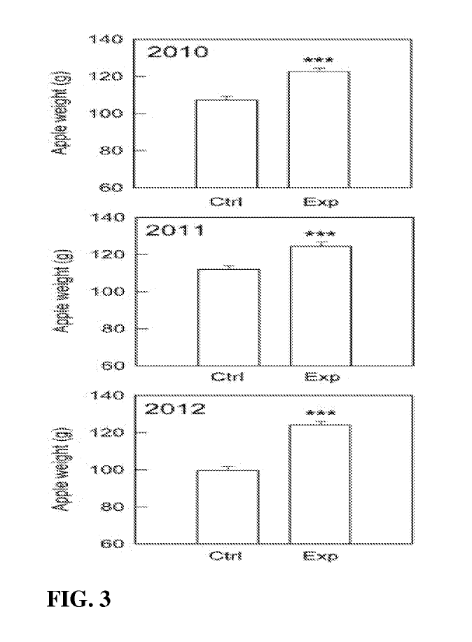

Interestingly, addition of L-aspartate increased average weight of apples (FIG. 3; N=198-200; P<0.001, Student's t-test). In 2010, the weight of apples from the trees treated with L-aspartate-insecticide mixtures was higher than that of the apples from the trees treated with insecticides alone by approximately 15%, in 2011 by approximately 11%, and in 2012 by approximately 27%.

The idea of enhancing insecticide efficacy against phytophagous insects with feeding stimulators is not new. A number of insect feeding stimulators based on sugars, molasses, and cottonseed extracts have been advocated, commercially manufactured, and used in the field to enhance insect controlling agents. Those adjuvants were biologically active at 5% concentrations, and their sticky consistency often poses practical problems during their application in the field. Here, the tests results show that L-aspartate stimulates feeding at concentrations much lower than 5%, and acts as an effective additive by increasing efficacy of insecticides, reducing fruit damage, and increasing the size of the fruit.

Feeding Stimulation. In our current study, L-aspartate increased food consumption by codling moth neonates at 1 mg/ml in 3-hour assays and at 0.1 mg/ml and 1 mg/ml in 24-hour assays. In both kinds of assays, L-aspartate has slightly lesser stimulatory effect on feeding than monosodium glutamate tested in earlier studies. In 3-hour assays, monosodium glutamate increased food consumption at 0.03 mg/ml, about three times lower concentration than in the case of L-aspartate (this study, FIG. 1A). In 24-hour assays, monosodium glutamate was effective at concentration of 0.05 mg/ml, which was two times lower than the lowest effective concentration of L-aspartate tested (FIG. 1B). Interestingly, Drosophila N-methyl-D-aspartate (NMDA) receptors are excited by either monosodium glutamate or L-aspartate, but at different concentrations; L-aspartate was about five times less potent than glutamate. Increased food consumption by codling moth neonates is likely mediated by glutamate NMDA receptors. The difference between glutamate and L-aspartate efficacy in our assays with codling moth neonates may reflect differential sensitivity of neonates' taste receptors.

In comparison with other insect feeding stimulants, L-aspartate has good stimulatory properties. Farrar and Ridgway (1994) studied effects of six commercial feeding stimulants available at that time (Pheast, Coax, Entice, Gusto, and Mo-Bait) in larvae of six lepidopteran species. These feeding stimulants consisted primarily of vegetable flours, oils, sugars, and (in the case of Pheast) inactive yeast. All, except Mo-Bait, contained significant amounts of proteins ranging from 32.8 to 43.8% and all were tested at 5% concentrations on foliage in 24-h assays. Of 36 experimental variants in their study, only 8 (Pheast, Coax, Entice, and Gusto in either Heliothis zea (Boddie) or Ostrinia nubilalis (Hubner) and Entice in Spodoptera exiqua (Hubner)), all at 5% concentrations, showed stronger feeding stimulation than that by 0.01% L-aspartate in codling moth neonates.

Toxicity Assays. Toxicities of insecticides measured as LC₅₀ in our laboratory assays on leaf discs are generally in accordance with the values reported for codling moth neonates by other authors. Gratwick et al. (1965) estimated toxicity of carbaryl in codling moth neonates in tests based on feeding the neonates on apples dipped in the insecticide. They estimated LC50 for this insecticide as 0.06 μg/cm² of the apple surface in two independent experiments. In these experiments we used disks of standardized size (113 mm²) and standard volume of the insecticide (10 μg) was applied to each leaf disc. This allowed for recalculation of the concentrations used for the toxicity assays to microgram per square centimeter of the leaf surface. Our recalculated LC₅₀ for carbaryl equals 0.047 μg/cm², which corresponds well with the data of Gratwick et al. (1965). Magalhaes and Walgenbach (2011) investigated toxicity of spinetoram on codling moth neonates by application of this insecticide onto diet surface and estimated the LC₅₀ 95% CI between 0.03 and 0.08 ppm (AI). In neonates of another Tortricid, Choristoneura rosaceana, exposed for 24 hours to insecticide residues on apple leaves, spinetoram caused 100% mortality at concentrations as low as 0.6 ppm (AI). In a study of acetamiprid effects in codling moth neonates, using a leaf dip assay, Brunner et al. (2005) reported the LC50 95% CI to fall between 1.4 and 5.1 mg (AI)/liter. Similarly, the experiments of Magalhaes and Walgen-bach (2011) showed that for neonate codling moth, the LC₅₀ of acetamiprid residues on artificial diet surface spans from 1.35 to 2.06 mg (AI)/liter with 95% confidence. Toxicity parameters of spinetoram and acetamiprid found in our study are in concordance with literature data

We are not aware of any reports showing toxicity parameters of β-cyfluthrin administered per os to neonates of any species, including the codling moth. The only report on stomach activity of β-cyfluthrin in lepidopteran larvae shows toxicity of this insecticide to fourth-instar larvae of Heliothis virescens (F.) and Spodoptera littoralis (Boisduval). The larvae in their experiments were fed artificial diet containing different concentrations of β-cyfluthrin. The LC50s were established at 3.1 μg/g of diet for H. virescens and at 0.1 μg/g of diet for S. littoralis. Again, using disks of standardized size and standard volume of the insecticide applied to each leaf disc in our experiments allowed us to express our results in microgram per gram of foliage. LC50 of β-cyfluthrin in codling moth neonates expressed that way equals 1.24 μg/g of foliage, which is similar to the data of Lagadic et al. (1993).

Insecticide Enhancement. L-Aspartate enhanced efficacy of insecticides by a factor of approximately 10 (Table 1). Brownbridge (1993) reported enhancement of a B. thuringiensis formulation against Chilo partellus (Swinhoe) by factors of 2.6-3.6 by addition of 10% molasses or sugar at concentrations of either 1 or 0.1%. Bartell et al. (1990) showed that efficacy of the same insecticide may be increased 1.5 or 6 times by addition of 4% corn oil and 5% Coax, respectively, when tested on O. nubilalis larvae. Meisner et al. (1990) reported that amounts of B. thuringiensis may be halved by the addition of 1% Coax against Boarmia selenaria (Schif-fermiller) larvae without losing efficacy of control. In a more recent study, El Mandarawy et al. (2004) reported enhancement of B. thuringiensis by a custom-made feeding stimulant containing disaccharides, hydrolyzed starch, whey, and vegetable oil and used at 1.75% concentration. Addition of this stimulant decreased LC₅₀ by 1.6-1.8 times in S. littoralis, Pectino-phora gosypiella (Saunders), and Earias insulana (Boisduval). Monosodium glutamate added to DiPel 2X DF against Ch. rosaceana lowered LC₅₀ for this insecticide from 450 to 150 μg/liter.

Insecticides other than B. thuringiensis were also successfully enhanced by addition of feeding stimulants. Toxicity of cypermethrin was increased 2.4 times and that of delthamethrin was increased 11.3 times by addition of 0.1% Coax (Meisner et al. 1984). LC50 values for chlorpyrifos were reduced by a factor of 1.15-1.4 in S. littoralis, P. gosypiella, and E. insulana by addition of the aforementioned custom-made phago-stimulant (El Mandarawy et al. 2004). Chandler (1993) was unable to significantly increase mortality from tebufenoside and diβubenzuron by adding either of three commercially available phagostimulants, Nu-Lure, Coax, or Konsume, in his tests with Spodoptera frugiperda (J. E. Smith), despite using concentrations as high as 10%. Efficacy of spinosad against codling moth neonates was enhanced almost two times by addition of a glutamate receptor agonist, trans-ACBD.

Addition of L-aspartate to insecticides tested in this current study provided markedly better insecticide enhancement ratios than most of those reported for other phagostimulants in studies on lepidopteran larvae.

The results of these experiments shows that increased toxicity after addition of L-aspartate is caused by increased feeding on insecticide residues in the presence of this feeding stimulant (FIG. 2). In all cases, insecticide exposure alone lowered insect feeding activity, which is consistent with literature data (Young and McMillian 1979, Bernard and Lagadic 1993, Yee, 2009, Sial and Brunner 2010). However, in all cases, L-aspartate stimulated feeding in presence of insecticide residues, and in the case of Delegate WG and Assail 30 SG, abolished feeding inhibitory effects of these two insecticides. Reversal of feeding inhibitory effects of spinetoram or acetamiprid by addition of a feeding stimulant is heretofore unknown.

In field experiments, addition of L-aspartate reduced fruit damage from codling moth of both generations (FIG. 2). The damage reduction by codling moth resembled values previously reported by other authors. Bell and Kanavel (1977) reported reduction of cotton ball damage by Heliothis ssp. from 6.4 to 2.1% and by P. gosypiella from 72 to 67% after enhancing nuclear polyhedrosis virus with a cottonseed-based phagostimulant. Johnson (1982) found that Gustol or Coax reduces damage of cotton by 8-13% if mixed into B. thuringiensis or Bacillus heliothis formulations. El Mandarawy et al. (2004) enhanced B. thuringiensis, Beauveria bassiana, and chlorpyrifos with a phago-stimulant containing vegetable oil, whey, hydrolyzed starch, and saccharides and obtained similar results in their field research. In cotton treated with a mixture of insecticide and phagostimulant, damage by S. littoralis was reduced by 1-5% and that by P. gossypiella by 1-11% compared with the fields sprayed by respective insecticide alone (El Mandarawy et al. 2004). The results reported by aforementioned authors closely correspond with the data from our current study on L-aspartate (fruit damage was reduced by 5% in the first generation and by 15% in second generation of codling moth). Recently, Knight and Witzgall (2013) reported enhancing codling moth granulovirus (CpGV) with sugar and the yeast Metschnikowia pulcherrima against codling moth neonates. The reduction of apple damage at harvest was similar to that observed in our study; from 34% for CpGV alone to 22% for CpGV in combination with the yeast and sugar. However, the concentrations of their additives were 3.5 times higher than the concentration of L-aspartate in our study (3.6 g/liter of the yeasts in combination with 3.6 g/liter of sugar [Knight and Witzgall 2013] vs. 2.11 g/liter of L-aspartate.

Significant yield increase in the fruit coming from the trees sprayed with Las-partate-enhanced insecticides (FIG. 2) was also noticed. Explanation of this finding will require additional experiments, but it should be mentioned that a chemical substance closely resembling L-aspartate in terms of structure and biological activity, L-glutamate, is a component of a plant metabolic primer AuxiGro.

L-aspartate is a viable insecticide enhancer against the codling moth on apples. Moreover, increase of the fruit yield caused by L-aspartate additionally contributes to quantity of the harvest. Addition of L-aspartate to insecticides will allow reducing the amounts of active ingredients without losing insecticide efficacy.

What is claimed is:

1. A composition of L-aspartate and an insecticide for application to fruit trees wherein the L-aspartate increases leaf ingestion by insects.

2. The composition of claim 1 wherein the insecticide is selected from the group consisting of: Assail 30 SG (30% acetamiprid), Delegate WG (25% spinetoram), Baythroid XL (12.7% β-cyfluthrin), Carbaryl 80S (80% carbaryl), or a combination of two or more of the insecticides.

3. The composition of claim 1 wherein said composition comprises L-aspartate in solution at a concentration of between approximately 0.5 mg/ml and 10 mg/ml.

4. A method for preventing infestation of a plant by a pest, said method comprising the step of administering a composition to said plant, wherein said composition comprises a mixture of insecticide and an acidic amino acid.

5. The method of claim 4 wherein the acidic amino acid is L-aspartate.

6. The method of claim 4 wherein the pest is a codling moth.

7. A method for enhancing harvest yield from a fruiting plant comprising the steps of: providing a solution of acidic amino acid and an insecticide, spraying the solution onto the fruiting plant during the period of fruit maturation.

8. The method of claim 7 wherein the acidic amino acid is L-aspartate.

9. The method of claim 8 wherein the solution comprises a concentration of L-aspartate of from between approximately 0.5 g/liter and approximately 5 g/liter

10. The method of claim 9 wherein the solution comprises a concentration of L-aspartate of from between approximately 2 g/liter and approximately 2.25 g/liter.

11. The method of claim 10 wherein the solution comprises a concentration of L-aspartate of approximately 2.11 g/liter.

12. The method of claim 8 wherein the solution is sprayed onto the fruiting plant at an application of between approximately 100 grams of L-aspartate per hectare and approximately 500 grams of L-aspartate per hectare.

13. The method of claim 8 wherein the solution is sprayed onto the fruiting plant at an application of approximately 395 grams of L-aspartate per hectare.

14. The method of claim 8 adding the step of dissolving the L-aspartate in Triton X-100 prior to the step of preparing the solution.

15. The method of claim 7 adding the step of mixing a surfactant into the solution prior to spraying.

16. The method of claim 15 wherein the surfactant is Surf-Ac 820.
